(19) United States
(12) Patent Application Publication
(10) Pub. No.: US 2022/0144008 A1
(43) Pub. Date: May 12, 2022

(54) MECHANICAL PENCIL

(71) Applicant: MITSUBISHI PENCIL COMPANY, LIMITED, Tokyo (JP)

(72) Inventor: Takamasa Fukuda, Tokyo (JP)

(73) Assignee: MITSUBISHI PENCIL COMPANY, LIMITED, Tokyo (JP)

(21) Appl. No.: 17/439,109

(22) PCT Filed: Apr. 20, 2020
(86) PCT No.: PCT/JP2020/017097

§ 371 Date: Sep. 14, 2021

(30) Foreign Application Priority Data
Apr. 26, 2019 (JP) 2019-086723

(51) Int. Cl. B43K 21/16; B43K 21/00; B43K 21/22

(52) U.S. Cl. CPC B43K 21/16; B43K 21/22; B43K 21/006

(57) ABSTRACT

A mechanical pencil 1 includes a rotary member having a ball chuck 11, a rotation drive mechanism 30 having a rotary part 40 and driving the rotary part to rotate in one direction upon receiving a retracting motion in the axial direction due to writing pressure received by the lead clutched by the ball chuck and an advancing motion in the axial direction due to release of the writing pressure, and a cylindrical member 8 made of metal provided at one of the cylindrical barrel and the rotary member, the rotary member configured so as to rotate upon receiving rotational drive force of the rotary part whereby the lead clutched by the ball chuck rotates, the other of the cylindrical barrel and the rotary member slidingly contacting the surface of the cylindrical member whereby rotation of the rotary member due to the rotation drive mechanism is supported.

### FIELD

The present invention relates to a mechanical pencil.

### BACKGROUND

Known in the art is a mechanical pencil which comprises a rotary member including a slider provided with a ball chuck allowing advance of lead and blocking retraction and a rotation drive mechanism having a rotary part and driving rotation of the rotary part in one direction upon receiving a retracting motion in the axial direction due to writing pressure received by the lead clutched by the ball chuck and an advancing motion in the axial direction due to release of the writing pressure and which is configured so that the lead rotates due to the ball chuck rotating upon receiving rotational drive force of the rotary part (see PTL 1).

### CITATIONS LIST

### Patent Literature

[PTL 1] WO2007/142135

### SUMMARY

### Technical Problem

Usually, a writing motion is performed in a state with a mechanical pencil made to slant from a state vertical to the writing surface. The above-mentioned retracting motion in the axial direction due to the writing pressure is performed by the force component in the axial direction of the force due to the writing pressure applied vertically to the writing surface by the mechanical pencil in the slanted state. The force component in the direction vertical to the axial direction in the force due to pressure increases the resistance of the rotary member at the time of rotation. That is, an outer surface of the rotary member slidingly contacts a cylindrical barrel, for example, the tip member, whereby rotation of the rotary member by the rotation drive mechanism is supported, but the above-mentioned force component in the vertical direction increases the sliding resistance, that is, the frictional resistance. If the frictional resistance is large, a user with a particularly small writing pressure is liable to be unable to make the rotary member rotate by the rotation drive mechanism. In particular, if the outside diameter of the rotary member is large, the moment of the force due to the frictional resistance also becomes larger.

The present invention has as its object the provision of a mechanical pencil reducing the frictional resistance at the time of rotation of a rotary member due to a rotation drive mechanism.

### Solution to Problem

According to one aspect of the present invention, there is provided a mechanical pencil which comprises a cylindrical barrel, a rotary member having a ball chuck allowing advance of lead and blocking retraction, a rotation drive mechanism having a rotary part and driving the rotary part to rotate in one direction upon receiving a retracting motion in the axial direction due to writing pressure received by the lead clutched by the ball chuck and an advancing motion in the axial direction due to release of the writing pressure, and a cylindrical member made of metal provided at one of the cylindrical barrel and the rotary member, the rotary member configured so as to rotate upon receiving rotational drive force of the rotary part whereby the lead clutched by the ball chuck rotates, the other of the cylindrical barrel and the rotary member slidingly contacting the surface of the cylindrical member whereby rotation of the rotary member due to the rotation drive mechanism is supported.

The cylindrical member may be provided at the rotary member. The cylindrical member may be a front end pipe holding the lead.

### Advantageous Effects of Invention

According to the aspects of the present invention, the common effect is exhibited of provision of a mechanical pencil reducing the frictional resistance at the time of rotation of a rotary member due to a rotation drive mechanism.

### BRIEF DESCRIPTION OF DRAWINGS

FIG. 1 is a vertical cross-sectional view of a mechanical pencil according to an embodiment of the present invention.

FIG. 2 is an enlarged cross-sectional view of a front half of the mechanical pencil of FIG. 1.

FIG. 3 is an enlarged cross-sectional view of a rear half of the mechanical pencil of FIG. 1.

FIG. 4 is an enlarged cross-sectional view of a rotation drive mechanism.

FIG. 5 is a schematic view explaining drive of rotation of a rotary part of the rotation drive mechanism.

FIG. 6 is a schematic view explaining drive of rotation of a rotary part following FIG. 5.

FIG. 7 is a perspective view of a dial cam member.

FIG. 8 is a perspective view of a rail cam member.

FIG. 9 is another perspective view of a rail cam member.

FIG. 10 is a perspective view of a combined dial cam member and rail cam member.

FIG. 11 is another perspective view of a combined dial cam member and rail cam member.

FIG. 12 is a schematic view showing a feed cam face in FIG. 10.

FIG. 13 is a schematic view showing a feed cam face in FIG. 11.

FIG. 14 is an enlarged cross-sectional view of a front end part of the mechanical pencil of FIG. 1.

FIG. 15 is a perspective view of a click cover.

FIG. 16 is a perspective view of a state attaching the click cover to a rear end part of the mechanical pencil.

FIG. 17 is a perspective view of a state attaching the click cover to a front end part of the mechanical pencil.

FIG. 18 is a perspective view of a first holding chuck.

FIG. 19 is a perspective view of a second holding chuck.

FIG. 20 is a perspective view of a holding chuck.

FIG. 21 is a view explaining motion of the holding chuck.

FIG. 22 is a view explaining motion of the first holding chuck.

### DESCRIPTION OF EMBODIMENTS

Below, embodiments of the present invention will be explained in detail while referring to the drawings. Throughout the drawings, the corresponding component elements will be assigned common reference notations.

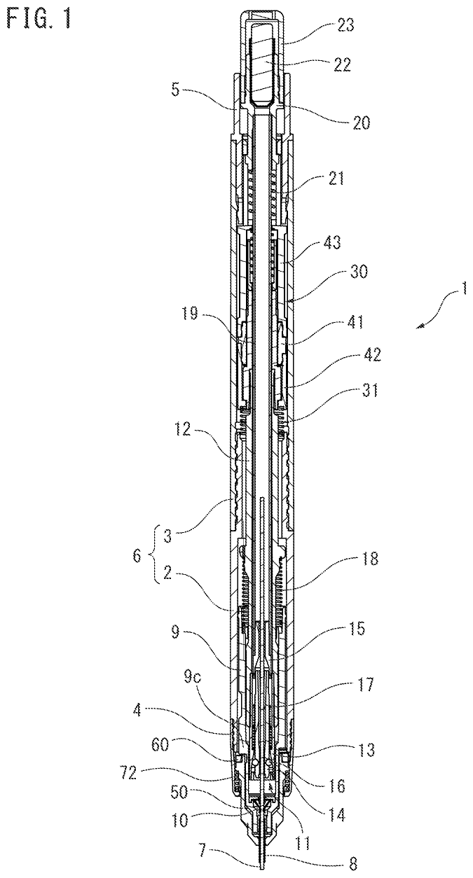

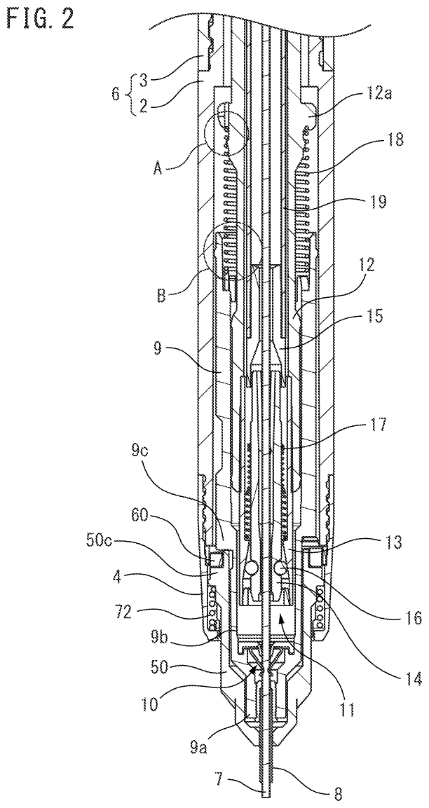

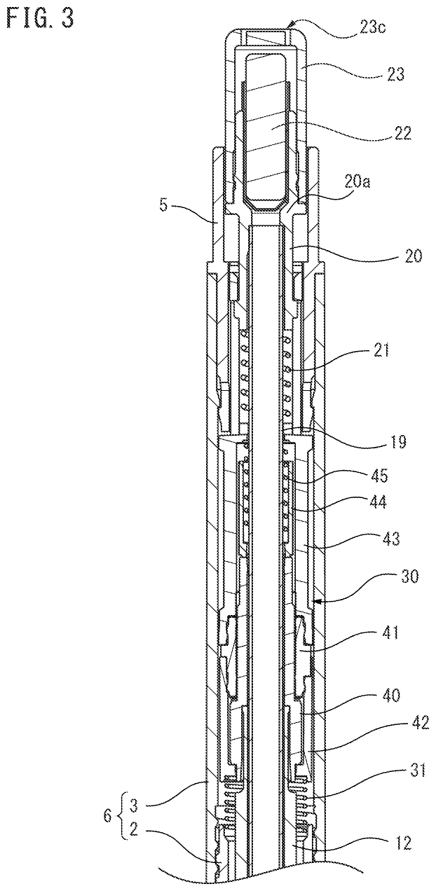

FIG. 1 is a vertical cross-sectional view of a mechanical pencil 1 according to an embodiment of the present invention, FIG. 2 is an enlarged cross-sectional view of a front half of the mechanical pencil 1 of FIG. 1, and FIG. 3 is an enlarged cross-sectional view of a rear half of the mechanical pencil 1 of FIG. 1.

The mechanical pencil 1 has a front shaft 2, a rear shaft 3 screwed together with an outer circumferential surface of a rear end part of the front shaft 2, a tip member 4 screwed together with the outer circumferential surface of a front end part of the front shaft 2, and an inner tube 5 fit together with an inner circumferential surface of a rear end part of the rear shaft 3. The front shaft 2 and rear shaft 3 form a cylindrical barrel 6. Note that, the tip member 4 or inner tube 5 and further the later explained dial cam member 50 as well may also be included as the “cylindrical barrel 6”. As explained later, the mechanical pencil 1 is configured so that the lead 7 projects out from the front end of the tip member 4. The vicinity of the front end of the lead 7 is covered by a front end pipe 8 guiding the lead 7. In this Description, in the axial direction of the mechanical pencil 1, the lead 7 side is defined as the “front” side and the side opposite to the lead 7 side is defined as the “rear” side.

Referring to FIG. 2, inside of the front end part of the cylindrical barrel 6, a slider 9 is arranged to be able to slide in the axial direction and to be able to rotate about its axis. The slider 9 is formed into a cylindrical shape with an outside diameter becoming narrower in stages toward the front. At a front end part 9a of the slider 9, the front end pipe 8 is attached. Further, at the front end part 9a behind the front end pipe 8, a holding chuck 10 formed with a through hole at the center is arranged. The through hole of the holding chuck 10 slidingly contacts the outer circumferential surface of the lead 7 and acts to temporarily hold the lead 7.

At the rear part of the outer circumferential surface of an intermediate part 9b behind the front end part 9a of the slider 9, in particular a base part of the intermediate part 9b, an abutting part 9c projecting out in the axial direction is formed integrally with the slider 9. At the outer circumferential surfaces of the front end part 9a and intermediate part 9b, a dial cam member 50 formed by a first cam member formed into a cylindrical shape and a rail cam member 60 formed by a second cam member formed into a ring shape are arranged in a state aligned in the axial direction. Part of the front end part 9a of the slider 9 projects out from the hole of the front end part of the dial cam member 50.

At the inside of the slider 9, a ball chuck 11 clutching the lead 7 and a relay member 12 formed into a cylindrical shape are arranged. The ball chuck 11 has a fastener 13 formed into a cylindrical shape, a chuck body 14 arranged inside the fastener 13, a chuck holder 15 formed into a cylindrical shape, and a plurality of balls 16. At the inner circumferential surface of the fastener 13, a taper surface expanding toward the front is formed. The chuck body 14 is formed with a through hole for the lead 7 along its center axis. The front end part of the chuck body 14 is split into a plurality of sections along the axial direction. The rear end part of the chuck body 14 is held by the chuck holder 15. The chuck body 14 and chuck holder 15 can move with respect to the fastener 13 in the axial direction. The plurality of balls 16 are arranged between the inner circumferential surface of the fastener 13 and the outer circumferential surface of the chuck body 14.

If writing pressure is applied to the lead 7, the chuck body 14 abuts against the tapered surface inside the cylindrical shaped fastener 13 together with the balls 16, so the lead 7 is clutched by the chuck body 14. Due to this, retraction of the lead 7 is obstructed. On the other hand, if force acts pulling out the lead 7 to the front, the chuck body 14 does not receive the action due to the fastener 13, so the lead 7 can be pulled out to the front without resistance. That is, the ball chuck 11 acts to allow advance of the lead 7 and obstruct retraction.

A coil spring 17 is arranged so as to surround the chuck body 14. The rear end of the coil spring 17 fits with the outer circumference of the chuck body 14 while the front end of the coil spring 17 is supported by a step part formed at the inner circumferential surface of the fastener 13. The coil spring 17 biases the chuck body 14 to the rear. As a result, the ball chuck 11 can maintain the state of clutching the lead 7.

The outer circumferential surface of the rear end part of the fastener 13 fits with the inner circumferential surface of the front end part of the relay member 12. Therefore, the ball chuck 11 and relay member 12 can move inside the slider 9 in the axial direction. At the center part of the relay member 12 in the axial direction, a flange part 12a is formed. At the front of the flange part 12a, a cam abutting spring 18 formed by a coil spring is arranged so as to surround the relay member 12. The rear end of the cam abutting spring 18 is attached to the flange part 12a of the relay member 12 (part A), while the front end of the cam abutting spring 18 is attached to the inside wall of the rear end part of the slider 9 (part B). Inside the cylindrical barrel 6, the cam abutting spring 18 biases the slider 9 to the front. Due to this, the cam abutting spring 18, as explained later, acts to make an abutting part 9c provided at the slider 9 abut against the cam face. The rear end part of the relay member 12 is coupled with a later explained rotation drive mechanism 30. At the outer circumferential surface of the rear end part of the chuck holder 15, a front end part of a lead case 19 is fit. The lead case 19 is formed into a cylindrical shape. Inside, the lead 7 is housed.

Referring to FIG. 3, the rear end part of the cylindrical barrel 6, specifically the rear end part of the inner tube 5, is provided with, as a click member, a click rod 20 able to move back and forth with respect to the cylindrical barrel 6. The click rod 20 is biased to the rear by the coil spring 21. In the vicinity of the rear end part of the click rod 20, a partition wall part 20a provided with a refill hole of the lead 7 is formed. Inside of the rear end part of the click rod 20, an eraser 22 is detachably attached. At the outer circumferential surface of the rear end part of the click rod 20, a click cover 23 is detachably attached so the eraser 22 is protected from dirt etc. The click rod 20 fits with the outer circumferential surface of the rear end part of the lead case 19.

By a click operation pushing the click rod 20 or click cover 23 to the front, the lead case 19 advances. Due to this, the chuck body 14 is pushed out to the front through the chuck holder 15. Along with this, the lead 7 clutched by the chuck body 14 also advances whereby the lead 7 is fed out from the front end pipe 8. If the pressure due to the click operation is released, the click rod 20 retracts and returns to its original position due to the biasing force of the coil spring 21.

At this time, the chuck body 14 retracts due to the biasing force of the coil spring 17. On the other hand, the lead 7 is held by the holding chuck 10 arranged inside the slider 9, so due to the action of the ball chuck 11, the lead 7 is pulled out from the chuck body 14 without resistance. As a result, the lead 7 is fed out from the front end pipe 8, so it is possible to feed out a predetermined amount of lead 7 each time repeating the click operation. If maintaining the state of advance of the click rod 20 by the click operation, the state becomes one where the chuck body 14 projects out from the fastener 13 and the clutch of the lead 7 is released. In this state, the lead 7 fed out from the front end pipe 8 can be pushed back by a finger etc.

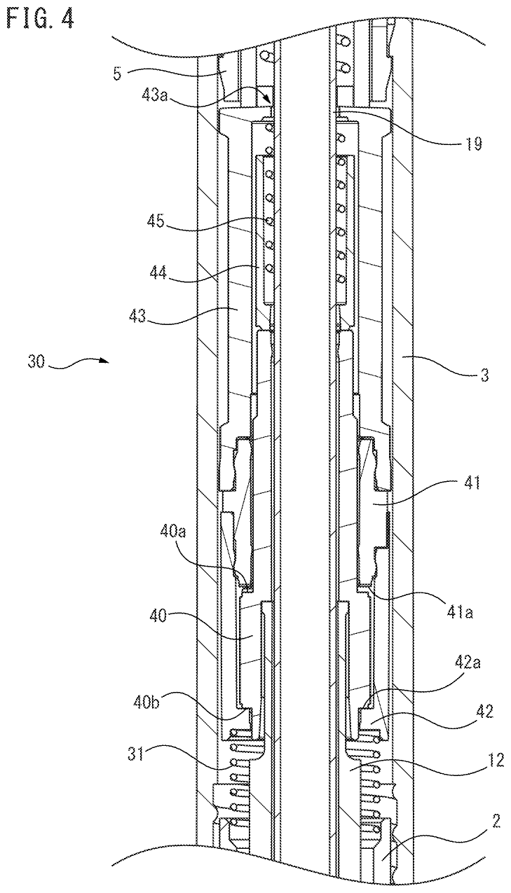

FIG. 4 is an enlarged cross-sectional view of the rotation drive mechanism 30. The rotation drive mechanism 30 is arranged at the inside space of the rear shaft 3. The rotation drive mechanism 30 is connected to the rear end part of the relay member 12. Between the rear end face of the front shaft 2 and the front end face of the rotation drive mechanism 30, a shaft spring 31 is arranged whereby the rotation drive mechanism 30 is biased to the rear. Movement of the rotation drive 30 backward due to the biasing force of the shaft spring 31 is restricted by the rear end face of the rotation drive mechanism 30 abutting against the front end face of the inner tube 5. The lead case 19 passes through the inside of the relay member 12 and rotation drive mechanism 30 and separates from the rotation drive mechanism 30.

The rotation drive mechanism 30 has a rotary part 40 formed into a cylindrical shape, an upper cam forming member 41 formed by a first cam forming member formed into a cylindrical shape, a lower cam forming member 42 formed by a second cam forming member formed into a cylindrical shape, a cylinder member 43 formed into a cylindrical shape, a torque canceller 44 formed into a cylindrical shape, and a coil-shaped cushion spring 45. The rotation drive mechanism 30 is formed into a unit by assembling these members together.

At the inner circumferential surface of the front end part of the rotary part 40, the outer circumferential surface of the rear end part of the relay member 12 is fit. The vicinity of the front end part of the rotary part 40 has a part formed into a flange shape with a just slightly larger diameter. The rear end face of that part is formed with a first cam face 40a, and the front end face of that part is formed with a second cam face 40b.

The upper cam forming member 41 surrounds the rotary part 40 to be able to rotate at the rear of the first cam face 40a of the rotary part 40. The lower cam forming member 42 fits with the outer circumferential surface of the front end part of the upper cam forming member 41. The front end face of the upper cam forming member 41 facing the first cam face 40a of the rotary part 40 is formed with a first fixed cam face of a fixed cam face 41a. The inside surface of the front end part of the lower cam forming member 42 facing the second cam face 40b of the rotary part 40 is formed with a second fixed cam face of a fixed cam face 42a.

At the outer circumferential surface of the rear end part of the upper cam forming member 41, a cylinder member 43 formed in a cylindrical shape is fit. The rear end part of the cylinder member 43 is formed with an insertion hole 43a through which the lead case 19 can be inserted. Inside the cylinder member 43, a torque canceller 44 formed into a cylindrical shape and able to move in the axial direction is arranged. Between the inner surface of the front end part of the torque canceller 44 and the inner surface of the rear end part of the cylinder member 43, a cushion spring 45 is arranged. The cushion spring 45 biases the rotary part 40 forward through the torque canceller 44.

Here, the relay member 12 transmits the retracting and advancing motions (cushion motion) of the lead 7 based on the writing motion to the rotation drive mechanism 30, that is, the rotary part 40, and transmits the rotational motion of the rotary part 40 at the rotation drive mechanism 30 occurring due to the cushion motion to the ball chuck 11 in the state clutching the lead 7. Therefore, the lead 7 held at the ball chuck 11 also rotates.

Other than when writing by the mechanical pencil 1, that is, when writing pressure is not applied to the lead 7, the rotary part 40 is positioned at the front due to the biasing force of the cushion spring 45 through the torque canceller 44. Therefore, the second cam face 40b of the rotary part 40 is rendered a state abutting against and meshing with the second fixed cam face 42a. When writing by the mechanical pencil 1, that is, when writing pressure is applied to the lead 7, the ball chuck 11 retracts against the biasing force of the cushion spring 45. Along with this, the rotary part 40 also retracts. Therefore, the first cam face 40a of the rotary part 40 is rendered a state abutting against and meshing with the first fixed cam face 41a.

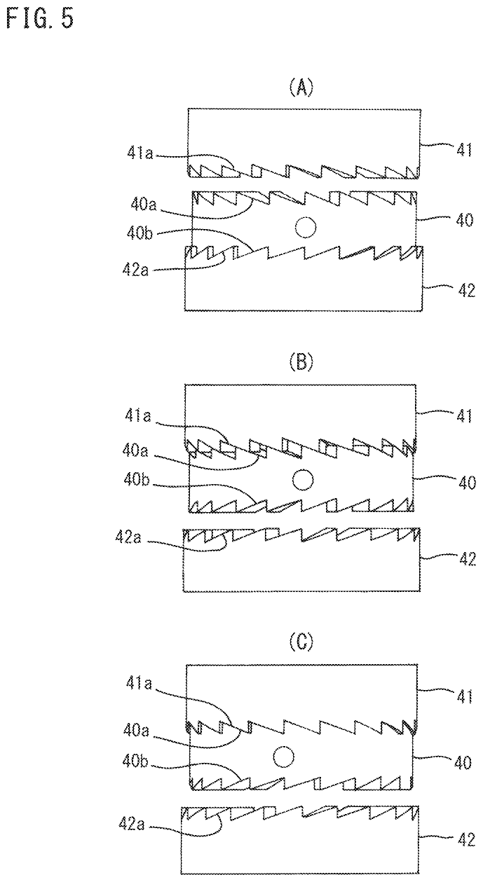

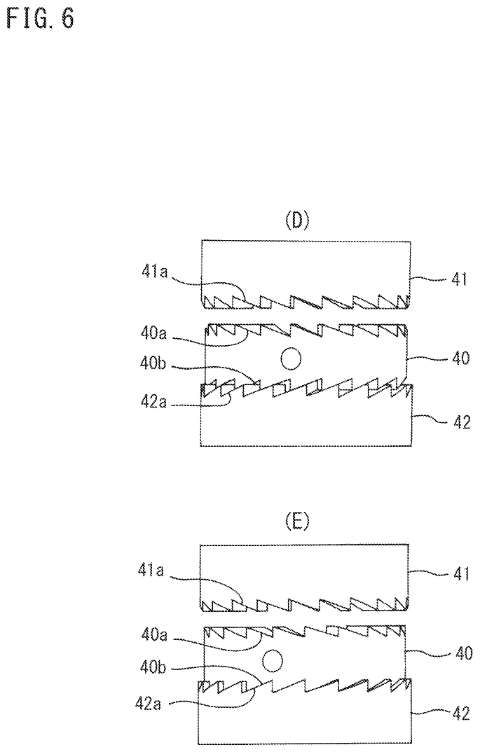

FIG. 5 is a schematic view successively explaining the rotation drive action of the rotary part 40 of the mechanical pencil 1 of FIG. 1, while FIG. 6 is a schematic view explaining the rotation drive action of the rotary part 40 continuing after FIG. 5. In FIG. 5 and FIG. 6, the rear end face formed by the surface at the upper side of the rotary part 40 is formed with the first cam face 40a in a ring shape rendered a continuous saw tooth shape along the circumferential direction, while the front end face formed by the surface at the lower side of the rotary part 40 is formed with a second cam face 40b in a ring shape similarly rendered a continuous saw tooth shape along the circumferential direction.

The ring-shaped end face of the upper cam forming member 41 facing the first cam face 40a of the rotary part 40 is also formed with a first fixed cam face 41a rendered a continuous saw tooth shape along the circumferential direction, while the ring-shaped end face of the lower cam forming member 42 facing the second cam face 40b of the rotary part 40 is formed with a second fixed cam face 42a rendered a continuous saw tooth shape along the circumferential direction. The cam faces of the first cam face 40a and second cam face 40b formed at the rotary part 40 and the cam faces of the first fixed cam face 41a formed at the upper cam forming member 41 and the second fixed cam face 42a formed at the lower cam forming member 42 are formed so as to become substantially equal to each other in pitch.

FIG. 5A shows the relationship between the rotary part 50 and the upper cam forming member 41 and lower cam forming member 42 in a state where writing pressure is not being applied to the lead 7. In this state, the second cam face 40b formed at the rotary part 40 abuts against the second fixed cam face 42a of the lower cam forming member 42 by the biasing force of the cushion spring 45. At this time, the first cam face 40a of the rotary part 40 and the first fixed cam face 41a of the upper cam forming member 41 are set to become a relationship offset in the axial direction by half a phase (half a pitch) from one tooth of the cams.

FIG. 5B shows the initial state where writing pressure is applied to the lead 7 for writing by the mechanical pencil 1. In such a state, the rotary part 40 retracts while compressing the cushion spring 45 along with retraction of the ball chuck 11. Due to this, the rotary part 40 moves to the first fixed cam face 41a side of the upper cam forming member 41.

Next, FIG. 5C shows the state where further writing pressure is applied to the lead 7 and the rotary part 40 abuts against the first fixed cam face 41a of the upper cam forming member 41 and retracts. In this state, the first cam face 40a of the rotary part 40 meshes with the first fixed cam face 41a of the upper cam forming member 41. Due to this, the rotary part 40 is driven to rotate corresponding to half a phase (half a pitch) from one tooth of the first cam face 40a.

Note that, the circle marks at the center part of the rotary part 40 in FIG. 5 and FIG. 6 show the amount of rotational movement of the rotary part 40. Further, in the state shown in FIG. 5C, the second cam face 40b of the rotary part 40 and the second fixed cam face 42a of the lower cam forming member 42 are set to become a relationship offset in the axial direction by half a phase (half a pitch) from one tooth of the cams.

Next, FIG. 6D shows the initial state where writing by the mechanical pencil 1 ends and the writing pressure on the lead 7 is released. In this case, the rotary part 40 advances due to the biasing force of the cushion spring 45. Due to this, the rotary part 40 moves to the lower cam forming member 42 side.

Next, FIG. 6E shows the state where the rotary part 40a abuts against the first fixed cam face 41a of the upper cam forming member 41 and advances due to the biasing force of the cushion spring 45. In this case, the second cam face 40b of the rotary part 40 meshes with the second fixed cam face 42a of the lower cam forming member 42. Due to this, the rotary part 40 is again driven to rotate corresponding to half a phase (half a pitch) from one tooth of the second cam face 40b.

Therefore, as shown by the circle marks drawn at the center part of the rotary part 40, along with reciprocating movement of the rotary part 40 receiving the writing pressure in the axial direction, that is, forward and backward motion, the rotary part 40 is driven to rotate corresponding to one tooth (1 pitch) of the first cam face 40a and second cam face 40b. The lead 7 clutched by this is also similarly driven to rotate through the ball chuck 11. Therefore, due to one forward and backward motion of the rotary part 40 in the axial direction due to writing, the rotary part 40 is driven to rotate corresponding to one tooth of the cam. By repeating this, the lead 7 is successively driven to rotate. For this reason, it is possible to prevent the lead 7 from being unevenly worn along with progress in writing and possible to prevent the thickness of the drawn lines and darkness of the drawn lines from greatly changing.

Note that, the torque canceller 44 which receives the biasing force of the cushion spring 45 to push out the rotary part 40 to the front causes sliding between the front end face of the torque canceller 44 and the rear end face of the rotary part 40 to prevent transmission of the rotational movement of the rotary part 40 to the cushion spring 45. That is, due to the torque canceller 44, the rotational movement of the rotary part 40 is prevented from being transmitted to the cushion spring 45. Due to this, twist back (torque) of the cushion spring 45 obstructing the rotational motion of the rotary part 40 is prevented.

Due to the above, the mechanical pencil 1 has the ball chuck 11 and the rotary part 40 and is configured to release and clutch the lead 7 by forward and backward motion of the ball chuck 11 to enable the lead 7 to be fed out to the front. The ball chuck 11 is held inside the cylindrical barrel 6 so as to be able to rotate about the center axis in the state clutching the lead 7 and is configured to make the rotary part 40 rotate by forward and backward motion of the rotary part 40 through the ball chuck 11 due to the writing pressure of the lead 7 and transmit rotational movement of the rotary part 40 through the ball chuck 11 to the lead 7.

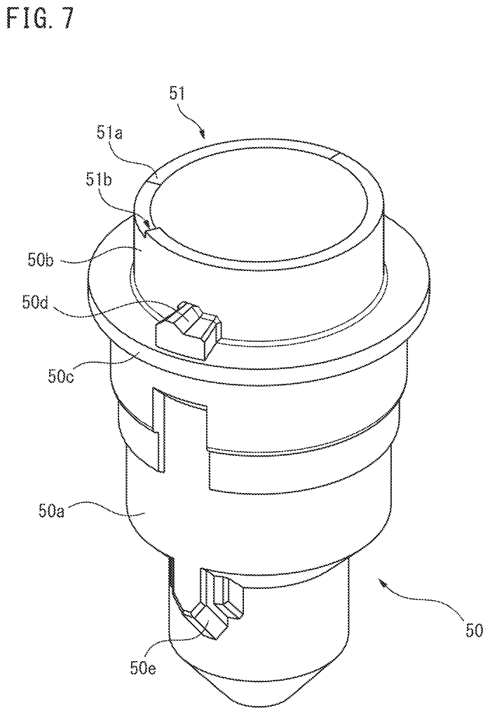

Referring to FIG. 7 to FIG. 9, the lead feed mechanism and feed adjustment mechanism will be explained. The lead feed mechanism receives the rotational drive force of the rotary part 40 of the rotation drive mechanism 30 and acts to feed out the lead 7 to the front.

FIG. 7 is a perspective view of the dial cam member 50. The dial cam member 50 is arranged so that its upper side becomes the rear side of the mechanical pencil 1 in FIG. 7. The dial cam member 50 is a member formed in a cylindrical shape and has a grip 50a positioned at the center in the axial direction, a small diameter part 50b formed in a smaller diameter than the grip 50a at the rear of the grip 50a, a flange part 50c formed in the front of the small diameter part 50b, two fitting projections 50d formed at the rear end face of the flange part 50c, and a dial cam 51 formed at the rear end face of the small diameter part 50b. The two fitting projections 50d are arranged symmetrically about the center axis. The front of the grip 50a is formed in a small diameter. Two locking projections 50e extending to the front from the grip 50a are formed symmetric about the center axis.

The dial cam 51 has a first slanted surface 51a such as a slope shape or spiral shape provided on the ring-shaped end face so as to rise along the circumferential direction and a first step part 51b provided in the axial direction between the start point (low position) and end point (high position) of the first slanted surface 51a. That is, the embodiment is configured so that the first step part 51b connects the start point and end point of the first slanted surface 51a.

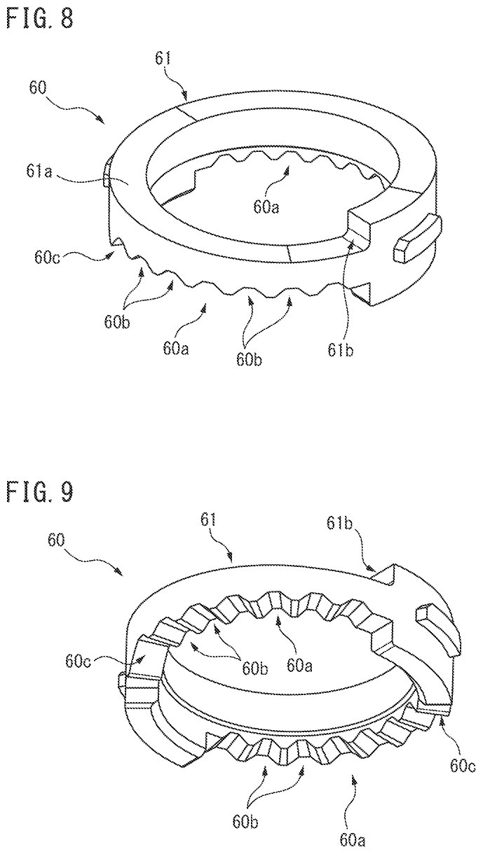

FIG. 8 is a perspective view of a rail cam member 60, while FIG. 9 is another perspective view of the rail cam member 60. The rail cam member 60 is arranged so that its upper side becomes the rear side of the mechanical pencil 1 in FIG. 8. The rail cam member 60 is a member formed in a ring shape. The front end face of the rail cam member 60 is formed with two adjusting recesses 60a symmetric about a center axis. Each of the adjusting recesses 60a is comprised of six first fitting recesses 60b formed by recesses of the same depths arranged alongside each other in the circumferential direction at equal intervals and one second fitting recess 60c formed by a recess shallower than the first fitting recess 60b.

At the rear end face of the rail cam member 60, a rail cam 61 is formed. The rail cam 61 has a second slanted surface 61a formed by a ring-shaped cam face such as a slope shape or spiral shape provided on the ring-shaped end face so as to rise along the circumferential direction and a second step part 61b provided in the axial direction between the start point (low position) and end point (high position) of the second slanted surface 61a. That is, the embodiment is configured so that the second step part 61b connects the start point and end point of the second slanted surface 61a. The second slanted surface 61a of the rail cam 61 is steeper than the first slanted surface 51a of the dial cam 51. The height of the second step part 61b of the rail cam 61 is higher than the height of the first step part 51b of the dial cam 51.

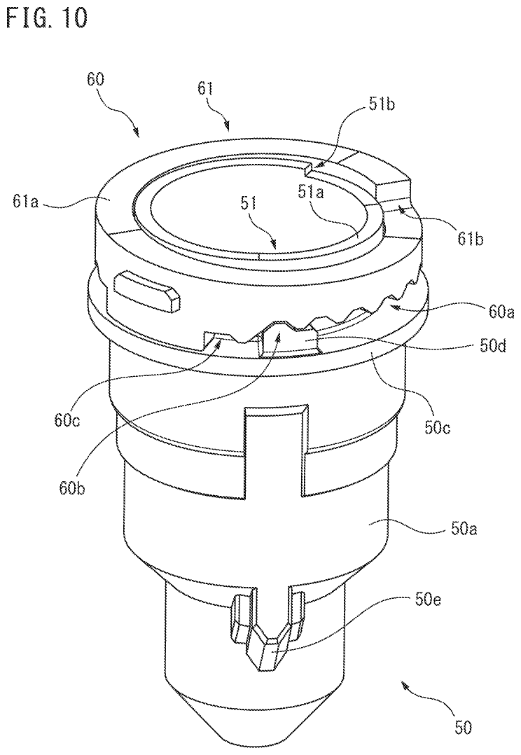

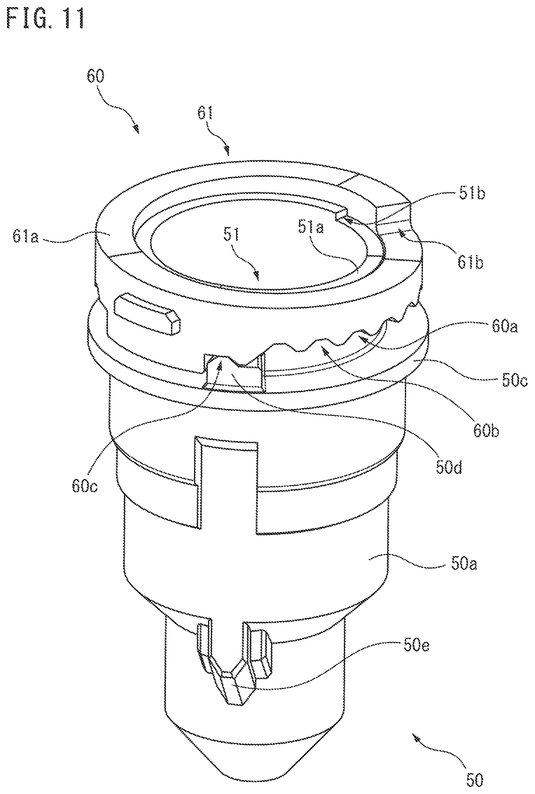

FIG. 10 is a perspective view of the dial cam member 50 and rail cam member 60 combined, while FIG. 11 is another perspective view of the dial cam member 50 and rail cam member 60 combined. The dial cam member 50 and rail cam member 60 are arranged so that the upper sides become the rear side of the mechanical pencil 1 in FIG. 10 and FIG. 11. The ring-shaped rail cam member 60 is inserted into the rear end part of the small diameter part 50b of the dial cam member 50 and is engaged by the flange part 50c to thereby be combined. That is, the front end face of the rail cam member 60 abuts against the rear end face of the flange part 50c of the dial cam member 50. More specifically, each of the fitting projections 50d provided at the flange part 50c of the dial cam member 50 fits into one of the first fitting recesses 60b or second fitting recess 60c of the adjusting recess 60a of the rail cam member 60. Accordingly, the rail cam member 60 is arranged at the outside of the dial cam member 50 in the radial direction. In FIG. 10, the fitting projection 50d fits into the first fitting recess 60b adjoining the second fitting recess 60c. Further, in FIG. 11, the fitting projection 50d fits into the second fitting recess 60c.

In the state where the dial cam member 50 and rail cam member 60 are combined, the dial cam 51 of the dial cam member 50 is arranged in the vicinity of the rail cam 61 of the rail cam member 60. Due to this, the dial cam 51 and rail cam 61 cooperate to form a continuous, that is, ring-shaped feed cam face 70 in the circumferential direction.

As shown in FIG. 2, the dial cam member 50 and rail cam member 60 are arranged at the outside of the front end part 9a and the intermediate part 9b of the slider 9 in the combined state. Part of the dial cam member 50 and the rail cam member 60 are covered by the tip member 4 at their outer circumferential surfaces. A coil spring 72 is arranged between the inner surface of the front end part of the tip member 4 and the flange part 50c of the dial cam member 50. Further, the cam abutting spring 18 biases the slider 9 to the front, so the abutting part 9c of the slider 9 maintains a state abutting against the feed cam face 70. The dial cam member 50 and rail cam member 60 are restricted in movement to the rear by the rear end face of the rail cam member 60 abutting against the front end face of the front shaft 2. Further, the outer circumferential surface of the rail cam member 60 engages with the inner circumferential surface of the tip member 4 whereby rotation of the tip member 4 of the rail cam member 60 and in turn the cylindrical barrel 6 is restricted.

The shape of the feed cam face 70 can be changed by making the dial cam member 50 and rail cam member 60 rotate relatively around the center axis. That is, a user grips the cylindrical barrel 6 with one hand and grips the grip 50a of the dial cam member 50 projecting out from the front end of the cylindrical barrel 6 with the other hand while making the dial cam member 50 rotate about the center axis with respect to the cylindrical barrel 6. The rail cam member 60 engages with the cylindrical barrel 6, so the dial cam member 50 rotates about the center axis with respect to the rail cam member 60.

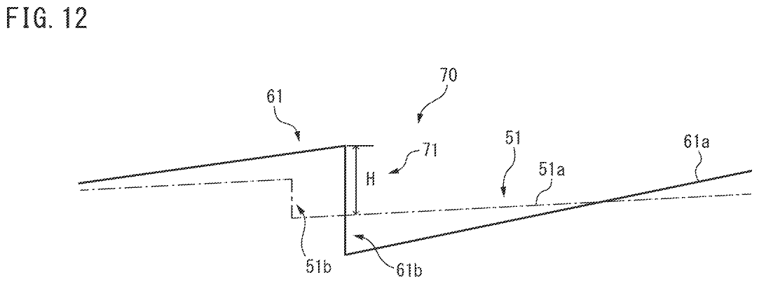

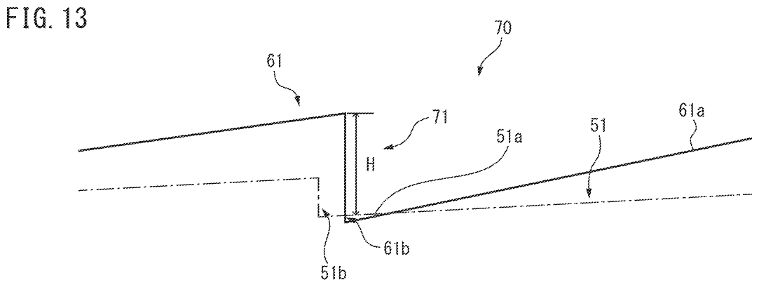

The dial cam member 50 is rotated with respect to the rail cam member 60 in a stepped manner so that the fitting projections 50d of the dial cam member 50 move to and fit together with the adjoining first fitting recesses 60b or second fitting recess 60c of the corresponding rail cam member 60. Therefore, the dial cam member 50 is rotated with respect to the rail cam member 60 about its center axis in a stepped manner in the range of the adjusting recesses 60a of the rail cam member 60 in which the fitting projections 50d of the dial cam member 50 can move. The relative positions of the rail cam 61 of the rail cam member 60 and the dial cam 51 of the dial cam member 50 change in accordance with the positions of the first fitting recesses 60b or second fitting recesses 60c of the rail cam member 60 in which the fitting projections 50d of the dial cam member 50 fit. As a result, the shape of the feed cam face 70 can be changed. The dial cam member 50 is biased with respect to the rail cam member 60 by the coil spring 72. A click feeling is obtained at the time of the stepped-like rotation of the dial cam member 50 with respect to the rail cam member 60. The change of the shape of the feed cam face 70 will be further explained while referring to FIG. 12 and FIG. 13.

FIG. 12 is a schematic view showing the feed cam face 70 of FIG. 10, while FIG. 13 is a schematic view showing the feed cam face 70 of FIG. 11. FIG. 12 and FIG. 13 show the positional relationship of the dial cam member 50 and rail cam member 60 by laying out in the circumferential direction the cylindrical surface around the center axis including the feed cam face 70. In FIG. 12 and FIG. 13, the upper side is the rear side of the mechanical pencil 1.

Referring to FIG. 12, the dial cam member 50 is made to be positioned with respect to the rail cam member 60 so that the first slanted surface 51a of the dial cam 51 and the second slanted surface 61a of the rail cam 61 are superposed in the diametrical direction. In FIG. 12, the series of surfaces positioned further to the rear in the first slanted surface 51a of the dial cam 51 and the second slanted surface 61a of the rail cam 61, that is, the upper side in the figure, forms the feed cam face 70. Note that, at the feed cam face 70, the height (height difference) of the step part 71 (drop difference) in the axial direction formed by the first slanted surface 51a of the dial cam 51 and the second step part 61b of the rail cam 61 is defined as the step height H.

Referring to FIG. 13, the dial cam member 50 is made to be positioned with respect to the rail cam member 60 so that, compared with the feed cam face 70 shown in FIG. 12, the second slanted surface 61a of the rail cam 61 is positioned more to the rear from the first slanted surface 51a of the dial cam 51. That is, in FIG. 13, as explained above, the fitting projections 50d fit with the second fitting recesses 60c formed by recesses shallower than the first fitting recesses 60b. Therefore, the rail cam 61 is arranged more to the rear from the dial cam 51. On the other hand, if the fitting projections 50d move between the six first fitting recesses 60b formed by recesses of the same depths, the rail cam 61 is at the same position in the axial direction with respect to the dial cam 51.

If focusing on the step height H, when the fitting projections 50d are fit with the first fitting recesses 60b furthest from the second fitting recess 60c in the adjusting recesses 60a, the step height H is the smallest. If the fitting projections 50d are fit with the first fitting recesses 60b closer to the second fitting recesses 60c, the step height H becomes larger proportionally to the slant of the first slanted surface 51a of the dial cam 51. That is, when the fitting projections 50d move between adjoining first fitting recesses 60b, the amounts of change of the step height H are constant. When moving from the state shown in FIG. 10 where the fitting projections 50d fit with the first fitting recesses 60b adjoining the second fitting recesses 60c to the state shown in FIG. 11 where they are fit with the second fitting recesses 60c, the amount of change of the step height H becomes maximum.

The rotary part 40 of the rotation drive mechanism 30 gradually drives the slider 9 to rotate based on the cushion motion of the lead 7. That is, when viewing the front end part 9a of the slider 9 first, the slider 9 rotates to the right about the center axis. Due to this rotational movement, the abutting part 9c of the slider 9 moves in the circumferential direction while cooperating with the feed cam face 70. That is, the abutting part 9c of the slider 9 moves so as to rise along the first slanted surface 51a of the dial cam 51 or the second slanted surface 61a of the rail cam 61 forming the feed cam face 70. At this time, the slider 9 gradually retracts.

When the abutting part 9c reaches the step part 71, it is pushed by the biasing force of the cam abutting spring 18 and falls into the step part 71. That is, the slider 9 moves forward more from the second slanted surface 61a of the rail cam 61 by exactly the step height H of the step part 71. At this time, the holding chuck 10 arranged inside of the slider 9 similarly moves forward, so the lead 7 held by the holding chuck 10 is pulled out from the ball chuck 11 and is fed out relatively from the front end pipe 8 by exactly the step height H. Therefore, the amount of the lead 7 which is fed out, that is, the amount of feed, is equal to the step height H.

Due to the above motion, it is possible to feed out the lead 7 from the front end pipe 8 every time the abutting part 9c circles once along the feed cam face 70. By repeating this motion, the lead 7 is worn down along with the writing motion while the lead 7 is successively fed out.

In short, the lead feed mechanism is configured so that when the abutting part 9c moves along the feed cam face 70 in accordance with rotation of the rotary part 40 and the abutting part 9c falls in the step part 71 of the feed cam face 70, the advancing motion of the slider 9 causes the lead 7 held by the holding chuck 10 to be pulled out from the ball chuck 11. The lead feed mechanism can utilizes the step part 71 of the feed cam face 70 to convert the rotational drive force of the rotary part 40 at the rotation drive mechanism 30 to a feed motion of the lead 7. The configuration for forming the height difference of the feed cam face 70 will be referred to overall as the “drop difference”.

Further, the mechanical pencil 1 is configured to drive rotation of the lead 7 held by the ball chuck 11 upon receiving the rotational drive force of the rotary part 40 at the rotation drive mechanism 30. Therefore, it is possible to prevent uneven wear of the lead 7 along with the progress in writing and as a result it is possible to prevent the thickness of the drawn lines or the darkness of the drawn line from greatly changing. In short, the rotation drive mechanism 30 has a rotary part 40 and drives rotation of the rotary part 40 in one direction upon receiving a retracting motion in the axial direction due to the writing pressure which the lead 7 clutched by the ball chuck 11 receives and the advancing motion in the axial direction due to release of the writing pressure.

Further, in the feed adjustment mechanism, as explained above, by just making the dial cam member 50 and rail cam member 60 rotate relatively about the center axis, it is possible to change the step height H of the step part 71 at the feed cam face 70. Accordingly, it is possible to more simply and accurately adjust the amount of feed of the lead 7 by the lead feed mechanism.

If making adjustments so that the extent of wear of the lead 7, which differs depending on the writing pressure, itself varying depending on the user, the hardness of the lead 7 used, etc., and the amount of feed of the lead 7 substantially match, it is possible to hold continuously constant the amount of projection of the lead 7 from the front end pipe 8 regardless of the writing motion. As a result, in the mechanical pencil 1, it is possible to continue writing for a long time by a single click operation. It is preferable to form the dial cam 51 so that the step part 71 having the step height H corresponding to a length exceeding the extent of wear of the lead 7 normally envisioned is formed. Due to this, it becomes possible to set the amount of feed of the lead 7 corresponding to the preferences of all users.

In particular, by the adjusting recesses 60a having the second fitting recess 60c formed by recesses shallower than the first fitting recesses 60b, at predetermined relative rotational positions of the dial cam member 50 and rail cam member 60, compared with other rotational positions, the dial cam member 50 and rail cam member 60 can be made to separate in the axial direction. In other words, the embodiment is configured so that the dial cam member 50 has the fitting projections, the rail cam member 60 has a plurality of fitting recesses able to fit with the fitting projections, and single ones of the plurality of fitting recesses are configured so that at the above predetermined rotational positions, the dial cam member 50 and rail cam member 60 are made to separate in the axial direction. As a result, the step height H of the step part 71 enables adjustment not proportionally, but to a great degree and enables great increase of the amount of feed. For example, if writing by a stronger writing pressure, the amount of wear of the lead 7 becomes greater than with normal writing pressure. In such a case, by making the amount of feed increase greatly, it becomes possible to continue writing for a long time by a single click operation.

In the above-mentioned embodiment, the dial cam member 50 was a cylindrical shaped member functioning as the first cam member, but it may also be a ring-shaped member. Further, the rail cam member 60 was a ring-shaped member functioning as the second cam member, but it may also be a cylindrical shaped member. The first cam member may be provided with the rail cam 61 and the second cam member may be provided with the dial cam 51. That is, the ring-shaped or cylindrical first cam member and the ring-shaped or cylindrical second cam member arranged at the outside from the first cam member in the diametrical direction may cooperate to form the feed cam face. Further, it is also possible to make the first cam member and second cam member move forward and backward relative to each other, that is, make them separate in the axial direction, to adjust the step height of the step part.

In this regard, in general, writing motion is performed in a state with the mechanical pencil made to tilt from the state vertical to the writing surface. In a mechanical pencil provided with a rotation drive mechanism, the retracting motion in the axial direction due to the writing pressure is performed by the axial direction force component of the writing pressure applied vertically to the writing surface by the mechanical pencil in the tilted state. The force component of the force due to the writing pressure in the direction vertical to the axial direction increases the resistance at the time of rotation of the rotary member rotating relatively to the cylindrical barrel. That is, by the outer surface of the rotary member slidingly contacting for example the tip member forming part of the cylindrical barrel, rotation of the rotary member by the rotation drive mechanism is supported, but the above-mentioned force component in the vertical direction makes the sliding resistance, that is, the frictional resistance, increase. If the frictional resistance is large, a user with a particularly small writing pressure is liable to be unable to make the rotation drive mechanism rotate. In particular, if the outside diameter of the rotary member is large, the moment of the force due to the frictional resistance also becomes larger.

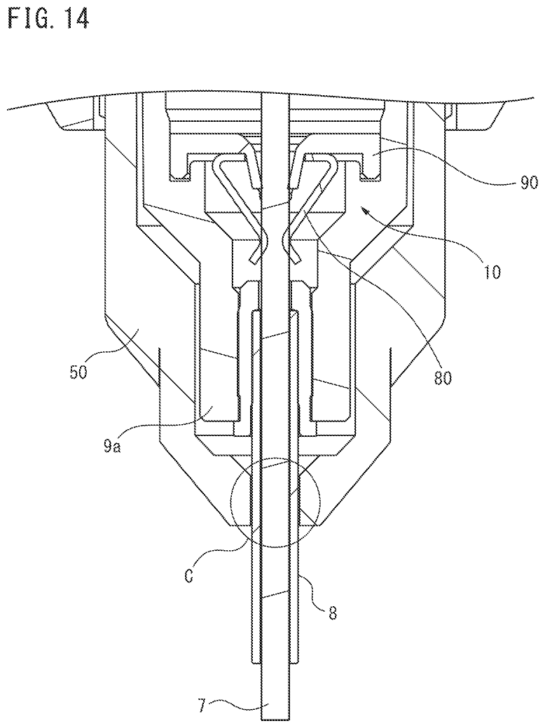

According to the mechanical pencil 1 according to an embodiment of the present invention, it is possible to reduce the frictional resistance at the time of rotation of the rotary member by the rotation drive mechanism. This will be explained while referring to FIG. 14.

FIG. 14 is an enlarged cross-sectional view of the front end part of the mechanical pencil 1 of FIG. 1. In the mechanical pencil 1, as explained above while referring to FIG. 2, the rear end of the cam abutting spring 18 is attached to the flange part 12a of the relay member 12 while the front end of the cam abutting spring 18 is attached to the inside wall of the rear end part of the slider 9. Further, the relay member 12 coupled with the rotary part 40 transmits the rotational drive force of the rotary part 40 in the rotation drive mechanism 30 to the ball chuck 11 in the state clutching the lead 7, but does not directly transmit it to the slider 9. That is, the slider 9 is arranged at the outside of the front end part of the relay member 12, but is not directly coupled to the relay member 12. Instead, the rotational drive force is transmitted from the rotary part 40 in the rotation drive mechanism 30 to the slider 9 through the cam abutting spring 18. In more detail, the cam abutting spring 18 biases the slider 9 forward to thereby function to make the abutting part 9c abut against the cam face and function also as a torsion spring.

Therefore, in the mechanical pencil 1, the slider 9, lead 7, and ball chuck 11 and, further, the front end pipe 8 attached to the slider 9 rotate upon receiving the rotational drive force of the rotary part 40 in the rotation drive mechanism 30. For this reason, these members including the front end pipe 8 form a rotary member rotating with respect to the cylindrical barrel 6. The rotation of the rotary member is supported by the front end pipe 8 slidingly contacting the cylindrical barrel 6, specifically the dial cam member 50, at the part C of FIG. 14. The outside diameter of the front end pipe 8 is just slightly larger than the outside diameter of the lead 7, so is extremely narrow compared with the other members of the rotary member. For this reason, the moment of the force due to the frictional resistance becomes smaller. Further, it is possible to reduce the contact area between the outer surface of the front end pipe 8 and the inner surface of the dial cam member 50 and possible to reduce more the frictional resistance at the time of rotation of the rotary member by the rotation drive mechanism 30. As a result, even a user with a small writing pressure can make the rotation drive mechanism 30 rotate in the mechanical pencil 1.

The front end pipe 8 is preferably a metal cylindrical member. On the other hand, the member at the cylindrical barrel 6 side, that is, the dial cam member 50, is an ABS, polycarbonate, or other hard plastic member. Therefore, compared with the case where a hard plastic cylindrical barrel and hard plastic rotary member slidingly contact each other, the frictional resistance is smaller in the case of a hard plastic cylindrical barrel and metal cylindrical member slidingly contacting each other. As a result, according to the mechanical pencil 1, it is possible to reduce more the frictional resistance at the time of rotation of the rotary member by the rotation drive mechanism 30.

The metal front end pipe 8 is manufactured by a drawing process, so the dimensional precision is also good. For example, in the case of a plastic part, the dimensional tolerance is ±0.02 mm, while in the case of a metal part, the dimensional tolerance can be made ±0.01 mm. For this reason, the clearance between the front end pipe 8 and the dial cam member 50 can be made smaller and rattling at the time of rotation of the rotary member can be reduced.

Note that, insofar as the sliding contact of the cylindrical barrel and the rotary member is performed by a metal cylindrical member, the cylindrical member can be formed in any way. For example, the metal cylindrical member may also be arranged not at the front end pipe 8, but the outer surface of the slider in the vicinity of the front end pipe, for example, the outer surface of the front end part 9a. Further, the metal cylindrical member may also be arranged not at the rotary member side, but at the part on the cylindrical barrel side slidingly contacting the rotary member, for example, the inner surface of the dial cam member 50.

That is, the mechanical pencil 1 according to an embodiment of the present invention is provided with a metal cylindrical member provided at one of the cylindrical barrel and rotary member, is configured so that the rotary member rotates upon receiving rotational drive force of the rotary part whereby the lead clutched by the ball chuck rotates, and the other of the cylindrical barrel and rotary member slidingly contacts the front surface of the cylindrical member, whereby rotation of the rotary member by the rotation drive mechanism is supported.

In this regard, in general, the click cover is detached at the time of use of the eraser. Further, when refilling the lead, the click cover and eraser are detached from the click member. The click cover is an extremely small part. When detached from the click member, the click cover may slip from the fingers and be lost. Further, even if leaving the click cover on a desk etc., since in general it has a cylindrical outer shape, the click cover may roll off the desk etc. and be lost.

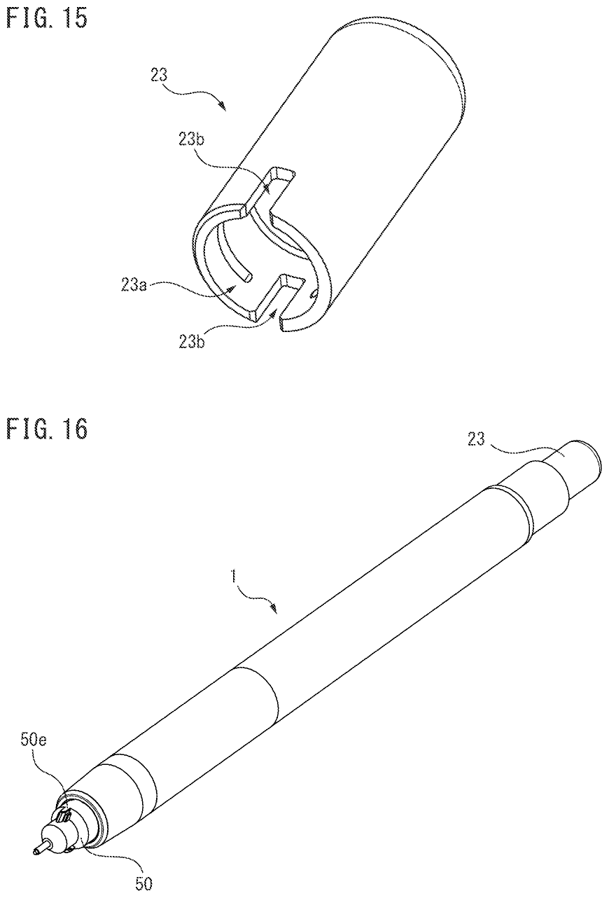

According to the mechanical pencil 1 according to an embodiment of the present invention, it is possible to prevent loss of the click cover. This will be explained while referring to FIG. 15 to FIG. 17.

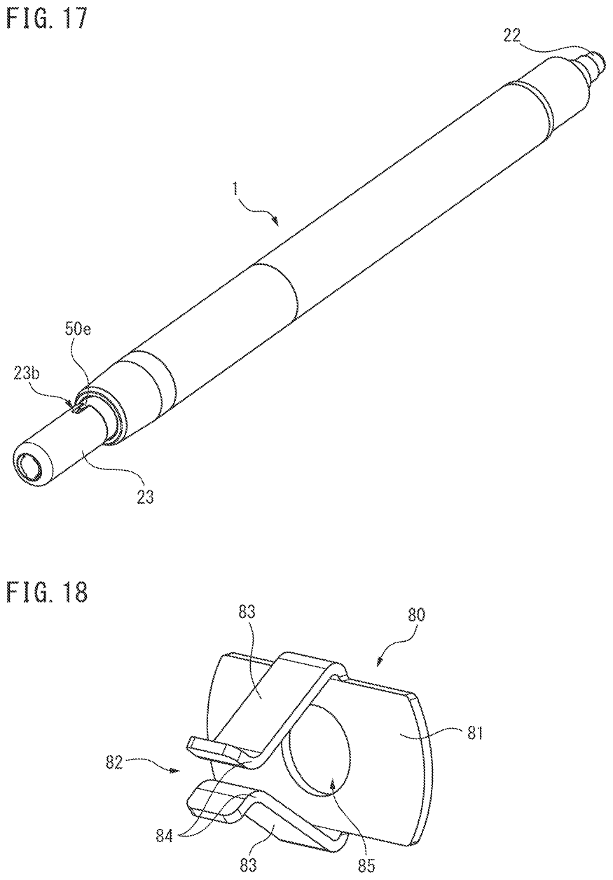

FIG. 15 is a perspective view of the click cover 23, FIG. 16 is a perspective view of the state where the click cover 23 is attached to the rear end part of the mechanical pencil 1, and FIG. 17 is a perspective view of the state where the click cover 23 is attached to the front end part of the mechanical pencil 1.

The click cover 23 is formed with an open end 23a. Inside the open end 23a, the rear end part of the click rod 20 is inserted, whereby the click cover 23 can fit with the outer circumferential surface of the click rod 20. The open end 23a of the click cover 23, that is, the open end face, is formed with two notched parts 23b symmetric about the center axis. In the click cover 23, the closed end part at the opposite side from the open end 23a is formed with a through hole 23c (FIG. 3). By formation of the through hole 23c, even if the click cover 23 is mistakenly swallowed by a young child, it's airway will not be closed and it becomes possible to secure safety.

As shown in FIG. 7 and FIG. 16, the dial cam member 50 formed by the front end part of the cylindrical barrel 6 is provided with two locking projections 50e. The click cover 23 can fit with the front end part of the cylindrical barrel 6. That is, the notched parts 23b of the click cover 23 fit with the locking projections 50e of the cylindrical barrel 6, whereby the click cover 23 can be detachably fit with the front end part of the cylindrical barrel 6.

In short, the click cover 23 can be fit with both the front end part and rear end part of the cylindrical barrel 6. Therefore, at the time of writing, by fitting the click cover 23 together with the rear end part of the cylindrical barrel 6, loss of the click cover 23 is prevented. On the other hand, when stored or when put away or otherwise when not writing or when refilling the lead etc., the click cover 23 is made to fit with the front end part of the cylindrical barrel 6, whereby loss of the click cover 23 is prevented.

In particular, in a mechanical pencil 1 having a feed adjustment mechanism, it is possible to grip the click cover 23 fit with the dial cam member 50 to thereby make the dial cam member 50 more easily rotate about the cylindrical barrel 6. That is, by fitting the click cover 23, the length of the grip 50a of the dial cam member 50 in the axial direction becomes substantially longer and more easily clutched, so a rotational force can more easily be applied.

Note that, if the mechanical pencil has no dial cam member, the click cover 23 may fit with any member, for example, the tip member, so long as able to fit with the front end part of the cylindrical barrel. That is, the click cover 23 may be fit with any member so long as it is able to fit with the rear end part of the cylindrical barrel and it is able to fit with the front end part of the cylindrical barrel. Further, in the above-mentioned embodiment, two locking projections are fit with two notched parts, but these may be configured so as to fit together in other numbers or shapes as well.

In this regard, the material of the holding chuck in general is nitrile rubber or another rubbery material. Therefore, the holding chuck sometimes deforms by creep deformation and falls in holding force due to aging. Further, if the lead is for example a product with a labeled diameter of, for example, 0.5 mm, the dimensions will sometimes vary in 0.55 mm to 0.58 mm in range. Therefore, due to variation in dimensions when formed by rubber, the holding force will sometimes become stronger and sometimes become weaker in relation to the variation with the dimensions of the lead.

According to the mechanical pencil 1 according to an embodiment of the present invention, it is possible to reduce the drop in the holding force accompanying aging and raise the dimensional precision. This will be explained while referring to FIG. 18 to FIG. 22.

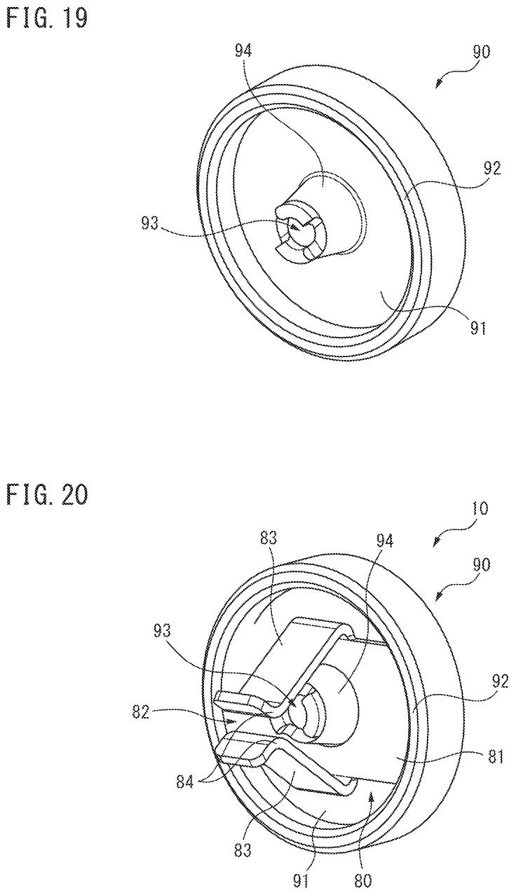

FIG. 18 is a perspective view of the first holding chuck 80, FIG. 19 is a perspective view of the second holding chuck 90, and FIG. 20 is a perspective view of the holding chuck 10. The holding chuck 10 has a first holding chuck 80 and a second holding chuck 90.

The first holding chuck 80 is a plate-shaped member made of metal and is press-formed. The first holding chuck 80 has an approximately rectangularly shape rectangular plate part 81 and a first holding part 82. The first holding part 82 is comprised of two plate-shaped members, that is, plate-shaped parts 83, extending from the center parts of the long sides of the rectangular plate part 81. The plate-shaped parts 83 extend bent so as to approach each other from the long sides of the rectangular plate part 81 and extend bent so as to separate from each other at the bent part 84. At the center of the rectangular plate part 81, a circular through hole, that is, a first insertion hole 85, is formed. The short sides of the rectangular plate part 81 are formed in arc shapes. As explained later, the lead 7 can be held by the first holding part 82.

The second holding chuck 90 is a disk-shaped member made of a nonmetallic material, for example, made of rubber or made or plastic. The second holding chuck 90 has a disk part 91, a peripheral wall 92 provided along the outer circumferential edge of one surface of the disk part 91, and a second holding part 94 defining a second insertion hole 93 at a center of the disk part 91 and projecting out from the disk part 91. The second holding part 94 has a frustoconical outer shape. Therefore, the second holding part 94 has a tapered outer circumferential surface and can hold the lead 7 at the opening of the narrowed front end.

Note that, the holding force of the lead 7 by the second holding part 94 of the second holding chuck 90 is set smaller than the holding force of the lead 7 by the first holding part 82 of the first holding chuck 80.

Referring to FIG. 20, the first holding chuck 80 is attached to the second holding chuck 90. Specifically, the short sides of the rectangular plate part 81 of the first holding chuck 80 made of metal engage with the peripheral walls 92 of the second holding chuck 90. At this time, the second holding part 94 of the second holding chuck 90 is inserted inside the first insertion hole 85 of the first holding chuck 80.

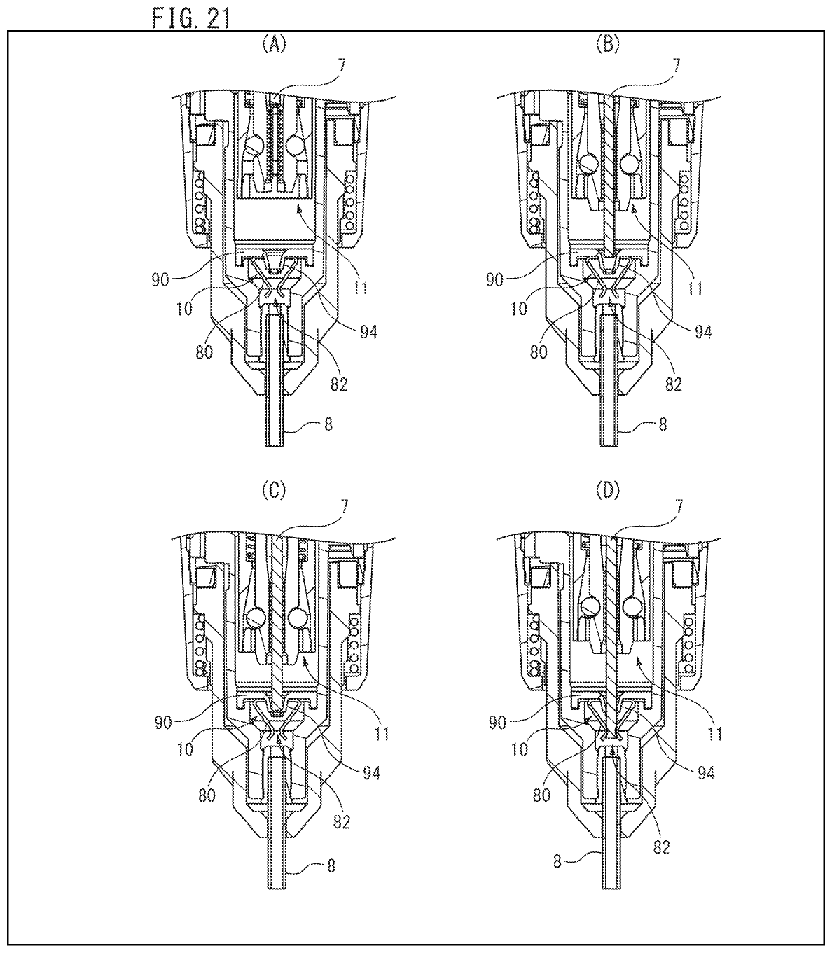

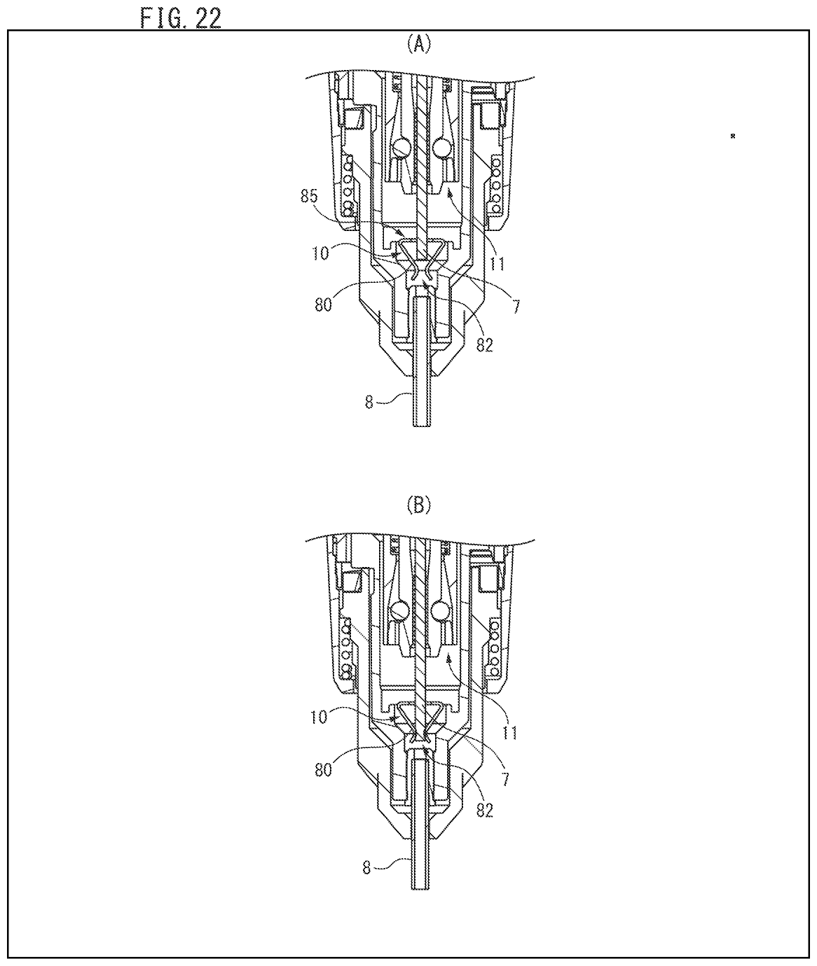

FIG. 21 is a view explaining motion of the holding chuck 10. FIG. 21A shows the state right after placing the lead 7 in the lead case 19. At this time, the ball chuck 11 still does not clutch the lead 7. If performing a click operation in this state, the lead 7 advances due to gravity and the ball chuck 11 clutches the lead 7 (FIG. 21B). Furthermore, if performing a click operation, the lead 7 advances to be inserted inside the second insertion hole 93 of the second holding chuck 90 and is held by the second holding part 94. Therefore, even after releasing the pressure by the click operation, the lead 7 is held by the second holding chuck 90 without retracting (FIG. 21C).

By further performing a click operation, the ball chuck 11 advances while clutching the lead 7 and the lead 7 is held by the first holding part 82 of the first holding chuck 80 (FIG. 21D). Specifically, by the lead 7 advancing, it is inserted between the two plate-shaped parts 83 of the first holding part 82. At this time, the lead 7 is clutched by elastic deformation of the first holding part 82, specifically elastic deformation of the two plate-shaped parts 83. Simultaneously, the lead 7 is also held by the second holding part 94 of the second holding chuck 90. Next, if releasing the pressure by the click operation, the lead 7 remains held by the first holding chuck 80 and second holding chuck 90 and only the ball chuck 11 retracts. Next, by repeating the click operation, it is possible to successively feed out the lead 7 a predetermined amount at a time linked with the above-mentioned forward and backward motion of the ball chuck 11.

In summary, the mechanical pencil 1 can hold the lead 7 by the holding chuck 10 comprised of the first holding chuck 80 having the first holding part 82 made of metal holding the lead 7 by elastic deformation of the first holding part 82. By making the first holding chuck 80 out of metal, it is possible to realize a holding chuck having less of a drop of the holding force due to aging and higher in dimensional precision compared with a conventional holding chuck.

In the above-mentioned embodiment, the first holding chuck 80 and the second holding chuck 90 are integrally arranged inside the cylindrical barrel 6, but the first holding chuck 80 and the second holding chuck 90 may also be arranged there separated from each other. Further, in the above-mentioned embodiment, the second holding chuck 90 is arranged behind the first holding chuck 80 inside the cylindrical barrel 6, but the second holding chuck 90 may also be arranged in front of the first holding chuck 80 integrally or separated from each other.

As explained above, the holding force of the lead 7 by the second holding part 94 of the second holding chuck 90 is set smaller than the holding force of the lead 7 by the first holding part 82 of the first holding chuck 80. Therefore, the second holding chuck 90 performs the role of an auxiliary holding chuck assisting the first holding chuck 80. By placing the second holding chuck 90 in addition to the first holding chuck 80 inside the cylindrical barrel 6, it becomes possible to more reliably hold the lead 7. The holding force of the lead 7 of the second holding chuck 90 may also be lower than the holding force of a conventional holding chuck.

Note that, in the above-mentioned embodiment, the holding chuck 10 had the first holding chuck 80 and the second holding chuck 90, but the holding chuck 10 may also just have the first holding chuck 80. The case where the holding chuck 10 just has the first holding chuck 80 will be explained while referring to FIG. 22.

FIG. 22 is a view explaining motion of the first holding chuck 80. FIG. 22A shows the state of loading the lead 7 into the lead case 19 and performing a click operation. The lead 7 passes through first insertion hole 85 and is arranged in the front of the first holding part 82. If further performing a click operation in this state, the lead 7 advances and is held by the first holding part 82 (FIG. 22B). Next, by repeating the click operation, the lead 7 can be successively fed out a predetermined amount at a time linked with the above-mentioned forward and backward motion of the ball chuck 11.

In the mechanical pencil 1 according to an embodiment of the present invention, by the holding chuck 10 having the first holding chuck 80 provided with the first holding part 82 made of metal, it is possible to obtain a holding chuck having less of a drop of the holding force due to aging and higher in dimensional precision compared with a conventional holding chuck made of a rubber material. Furthermore, the part of the first holding part 82 abutting against the lead 7, that is, the bent part 84, is formed in a curved shape, so the lead 7 is never damaged.

Note that, by the first holding chuck having the first holding part made of metal holding the lead by elastic deformation of the first holding part, it is possible to configure the first holding chuck in any way so long as able to hold the lead. For example, in the above-mentioned embodiment, the first holding part is comprised of two plate-shaped members, but it may also be comprised of three or more plate-shaped members. Further, the first holding part may also be comprised of not plate-shaped members, but bar-shaped members able to clutch the lead 7.

### REFERENCE SIGNS LIST

1 mechanical pencil
2 front shaft
3 rear shaft
4 tip member
5 inner tube
6 cylindrical barrel
7 lead
8 front end pipe
9 slider
9c abutting part
10 holding chuck
11 ball chuck
12 relay member
13 fastener
14 chuck body
15 chuck holder
16 ball
17 coil spring
18 cam abutting spring
19 lead case
20 click rod
21 coil spring
22 eraser
23 click cover
30 rotation drive mechanism
31 shaft spring
40 rotary part
40a first cam face
40b second cam face
41 upper cam forming member
41a first fixed cam face
42 lower cam forming member
42a second fixed cam face
43 cylinder member
44 torque canceller
45 cushion spring
50 dial cam member
50a grip
50b small diameter part
50c flange part
50d fitting projection
50e locking projection
51 dial cam
51a first slanted surface
51b first step part
60 rail cam member
60a adjusting recess
60b first fitting recess
60c second fitting recess
61 rail cam
61a second slanted surface
61b second step part
70 feed cam face
71 step part (drop difference)
72 coil spring
80 first holding chuck
81 rectangular plate part
82 first holding part
83 plate-shaped part
84 bent part
85 first insertion hole
90 second holding chuck
91 disk part
92 peripheral wall
93 second insertion hole
94 second holding part

1. A mechanical pencil, comprising:
a cylindrical barrel,
a rotary member having a ball chuck allowing advance of lead and blocking retraction,
a rotation drive mechanism having a rotary part and driving the rotary part to rotate in one direction upon receiving a retracting motion in the axial direction due to writing pressure received by the lead clutched by the ball chuck and an advancing motion in the axial direction due to release of the writing pressure, and
a cylindrical member made of metal provided at one of the cylindrical barrel and the rotary member,
the rotary member configured so as to rotate upon receiving rotational drive force of the rotary part whereby the lead clutched by the ball chuck rotates,
the other of the cylindrical barrel and the rotary member slidingly contacting the surface of the cylindrical member whereby rotation of the rotary member due to the rotation drive mechanism is supported.

2. The mechanical pencil according to claim 1, wherein the cylindrical member is provided at the rotary member.

3. The mechanical pencil according to claim 1, wherein the cylindrical member is a front end pipe holding the lead.

4. The mechanical pencil according to claim 2, wherein the cylindrical member is a front end pipe holding the lead.
